(19) United States
(12) Patent Application Publication
(10) Pub. No.: US 2016/0198645 A1
(43) Pub. Date: Jul. 14, 2016

(54) IRRIGATION CONTROL SYSTEMS AND METHODS

(71) Applicant: Sean B. Weatherill, Sausalito, CA (US)

(72) Inventor: Sean B. Weatherill, Sausalito, CA (US)

(21) Appl. No.: 14/990,641

(22) Filed: Jan. 7, 2016

Related U.S. Application Data
(60) Provisional application No. 62/101,288, filed on Jan. 8, 2015.

(51) Int. Cl. A01G 25/16

(52) U.S. Cl. CPC A01G 25/16

(57) ABSTRACT

An irrigation control system is disclosed. The irrigation control system can include an irrigation controller configured to intercept commands sent from a control unit of an irrigation system to one or more valves of the irrigation system. The irrigation control system can also include a master control valve configured to be disposed on a water supply line upstream of the one or more valves. A communications system comprising one or more processors can be configured to receive data from the master control valve over a communications network, the data related to a flow of water through the water supply line. The communications system can be configured to transmit information to the irrigation controller, the information comprising at least one of: current weather conditions, local water control restrictions, local moisture content, location of the irrigation system, user-defined limits, and flow rate of water through the irrigation system.

### CROSS-REFERENCE TO RELATED APPLICATIONS

This application claims priority to U.S. Provisional Patent Application No. 62/101,288, filed on Jan. 8, 2015, the entire contents of which are incorporated by reference herein in their entirety and for all purposes.

### BACKGROUND OF THE INVENTION

1. Field

The field relates generally to systems and methods for controlling the irrigation of land with water.

2. Description of the Related Art

Conventional irrigation control systems can be programmed by a user to supply water to a parcel of land (such as a yard or garden of a residence) at predetermined time periods. For example, the user can instruct the system to irrigate the parcel at a certain time for a particular duration one or more days per week. Some conventional timed controllers allow for different timing on different days of the week or months of the year. However, typical users do not often change the programming on their conventional controller for changing circumstances, and are either unwilling or unable to make adjustments after the system is originally set up. More sophisticated or “smart” controllers allow for dynamic control of irrigation timing and duration, but users can be discouraged by the expense and waste of replacing their conventional irrigation control systems and/or daunted by the learning required to implement the systems. Maintaining the pre-programmed irrigation schedules of a conventional control system regardless of circumstances can lead to overwatering and water wastage. Accordingly, there remains a continuing need to provide improved irrigation control systems.

### SUMMARY

In one embodiment, an irrigation controller is disclosed. The irrigation controller can include an electrical input connection configured to electrically communicate with a control unit of an external irrigation system. The irrigation controller can include an electrical output connection configured to electrically communicate with one or more valves of the external irrigation system. The irrigation controller can also include a control module comprising one or more processors and configured to monitor instructions received at the electrical input from the control unit, the instructions comprising commands for opening or closing the one or more valves. The control module can be configured to receive data transmitted over a communications network from an external communications system. The control module can be configured to prevent, allow or modify the commands for opening or closing the one or more valve to be transmitted from the electrical output connection to the one or more valves based at least in part on the received data.

In another embodiment, a master control valve is disclosed. The master control valve can include a valve body configured to be disposed on a water supply line upstream of one or more valves of an external irrigation system, the valve body configured to control a flow of water through the water supply line. The master control valve can include a sensor configured to transduce information regarding the flow of water and to generate a signal based on the transduced information. The master control valve can also include a control module comprising one or more processors and configured to receive the signal from the sensor. The control module can be configured to process the received signal to determine at least one of an amount of water flowing through the water supply line to the one or more valves and a time period during which water flows through the water supply line to the one or more valves. The control module can be configured to transmit the processed signal over a communications network to an external communications system.

In yet another embodiment, an irrigation control system is disclosed. The irrigation control system can include an irrigation controller configured to intercept commands sent from a control unit of an irrigation system to one or more valves of the irrigation system, the irrigation controller configured to prevent, allow, or modify the intercepted commands to be transmitted to the one or more valves. The irrigation control system can include a master control valve configured to be disposed on a water supply line upstream of the one or more valves, the master control valve configured to determine at least one of an amount of water flowing through the water supply line to the one or more valves and a time period during which water flows through the water supply line to the one or more valves. The irrigation control system can also include a communications system comprising one or more processors and configured to receive data from the master control valve over a communications network, the data related to a flow of water through the water supply line. The communications system can be configured to transmit information to the irrigation controller, the information comprising at least one of: current weather conditions, local water control restrictions, local moisture content, location of the irrigation system, user-defined limits, and flow rate of water through the irrigation system.

In another embodiment, an irrigation control system is disclosed. The irrigation control system can include an irrigation control unit configured to be programmed by a user to control the operation of an irrigation system. The irrigation control system can include one or more valves in electrical communication with the irrigation control unit, the one or more valves controlling the flow of water to one or more irrigation lines in response to a control signal sent from the irrigation control unit. The irrigation control system can also include an irrigation controller disposed between and in electrical communication with the irrigation control unit and the one or more valves, the irrigation controller configured to intercept commands sent from the control unit to the one or more valves, the irrigation controller configured to receive data over a communications network from an external communications system and configured to interrupt the control signal based at least in part on the received data.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Specific embodiments of the invention will now be described with reference to the following drawings, which are provided by way of example, and not limitation.

FIG. 1 is a schematic system diagram of an irrigation control system, according to one embodiment.

FIG. 2 is a schematic system diagram of the irrigation controller, according to one embodiment.

FIG. 3 is a schematic system diagram of the irrigation system shown in FIG. 1 with the irrigation controller connected to a signal line of each valve.

FIG. 4 is a schematic system diagram of the irrigation system shown in FIG. 1 with the irrigation controller connected to a ground line of the system.

FIG. 5 is a schematic system diagram of an irrigation control system, according to another embodiment.

FIGS. 6A-6C are schematic diagrams of a mobile device with a user interface that is configured to control the operation of the irrigation control system.

### DETAILED DESCRIPTION

Various embodiments disclosed herein relate to improved irrigation control systems that efficiently manage the irrigation of a parcel of land, such as a yard or garden of a residence. Conventional “dumb” or fixed-schedule irrigation systems can include a control unit that is programmed by a user to open and close one or more valves associated with a corresponding one or more irrigation lines. For example, in some arrangements, the irrigation system can include four irrigation lines that supply water to four different areas of the parcel of land. The user can program the system control unit to supply water to each of the four areas at a certain time and for a certain duration on one or more days of the week. For example, the user can program the irrigation system such that, on every Tuesday, Valve 1 is activated for 20 minutes at 8 am to supply water to Area 1, Valve 2 is activated for 30 minutes at 8:20 am to supply water to Area 2, Valve 3 is activated for 20 minutes at 8:50 am to supply water to Area 3, and Valve 4 is activated for 10 minutes at 9:10 am to supply water to Area 4. Thus, if the control unit of the conventional irrigation system is programmed in this manner, then water will be supplied to the parcel of land at these times and durations, regardless of local weather conditions, local watering restrictions, and other factors. Slightly more sophisticated fixed-schedule controllers allow for preprogramming multiple watering times per day, and programming of different schedules for different seasons. Although this example and the embodiments described herein include four irrigation lines, the skilled artisan will appreciate that irrigation systems may have any suitable number of irrigation lines, including fewer than or more than four lines.

Advantageously, the disclosed irrigation control systems can bring the sophistication of “smart” or dynamic controllers into the irrigation system while taking advantage of established conventional irrigation systems to improve the management of the irrigation system. For example, consumers may desire the functionality of a smart or dynamic controller, but may be unwilling to accept the expense and/or hassle of replacing their existing controller. Thus, the embodiments disclosed herein can advantageously act as a retrofitting system for conventional fixed-schedule irrigation systems, such that expense and barriers to adoption are reduced. For example, the disclosed embodiments can utilize data about current weather conditions or local watering restrictions (e.g., local regulations that are imposed in a particular area due to drought conditions, etc.), network-connected manual or automated override, among other factors, to adjust the times and durations of irrigation. The disclosed embodiments can also advantageously be used to retrofit conventional irrigation systems so that users need not replace these systems, and can reduce water usage relative to the use of the conventional irrigation systems alone.

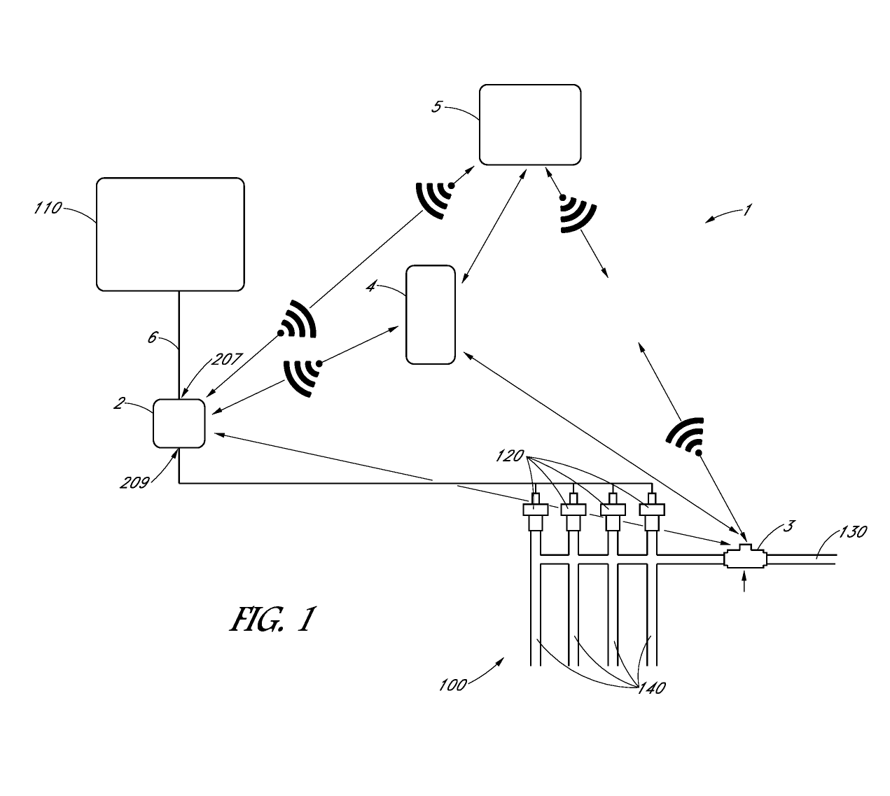

FIG. 1 is a schematic system diagram of an irrigation control system 1, according to one embodiment. The irrigation control system 1 can be used in connection with a conventional irrigation system 100. The irrigation system 100 can include a water supply line 130 that supplies water from a source (such as a city water supply) to a plurality of irrigation lines 140. In some arrangements, each irrigation line 140 supplies water to a particular area of the parcel of land. Although four irrigation lines 140 are shown in FIG. 1, it should be appreciated that the irrigation system 100 can include any suitable number of irrigation lines 140. Furthermore, although not illustrated in FIG. 1, it should be appreciated that the irrigation lines 140 may terminate at a sprinkler head or other distribution apparatus which distributes the water to the parcel of land. In some arrangements, the distribution apparatus can comprise a soaker hose segment or other device which allows water to slowly disperse into the ground. In other arrangements, the distribution apparatus can include a nozzle which sprays water across an area of the land. In still other arrangements, the distribution apparatus may include a perforated line for drip irrigation.

The irrigation system 100 can include one or more valves 120 configured to control the flow of water from the supply line 130 to each irrigation line 140. For example, each valve 120 can be selectively actuated to open, close, or partially open the flow path to regulate the flow rate through each irrigation line 140. In some embodiments, for example, each valve 120 can be selectively actuated to open and/or close the flow path through each irrigation line 140. Thus, if a particular area of the parcel of land is to be irrigated, then the valve 120 associated with the irrigation line 140 that supplies water to that area can be opened to convey water from the supply line 130 to the irrigation line 140 and the area of the parcel, and can be closed to prevent water from passing from the supply line 130 to the irrigation line 140 and the area of the parcel.

The irrigation system 100 can include an irrigation control unit 110 that controls the operation of the valves 120. As explained above, the user can interact with the control unit 110 to program the system 100 to supply water to the parcel of land according to a predetermined schedule. When the predetermined schedule indicates that a particular valve 120 is to be opened, the control unit 110 can send a control signal and/or electrical power along a control line 6 (e.g., an electrical wire, an optical fiber, etc.) to the valve 120 to cause the valve 120 to open for the scheduled duration. When the scheduled duration ends, the control unit 110 can send a control signal to the valve 120 to cause the valve 120 to close. In some systems, the control unit 110 can also specify by way of the control signal the degree to which the valve 120 is to open.

As explained herein, the irrigation system 100 with the standard control unit 110 may not be configured to adjust or modify the irrigation schedule based on events, such as weather changes (e.g., rainfall or drought), local watering restrictions, user preferences, data from local water sensors, and/or other factors. Advantageously, the irrigation control system 1 can include an irrigation controller 2 configured to be disposed along the control line 6 between the control unit 110 of the irrigation system 100 and the one or more valves 120.

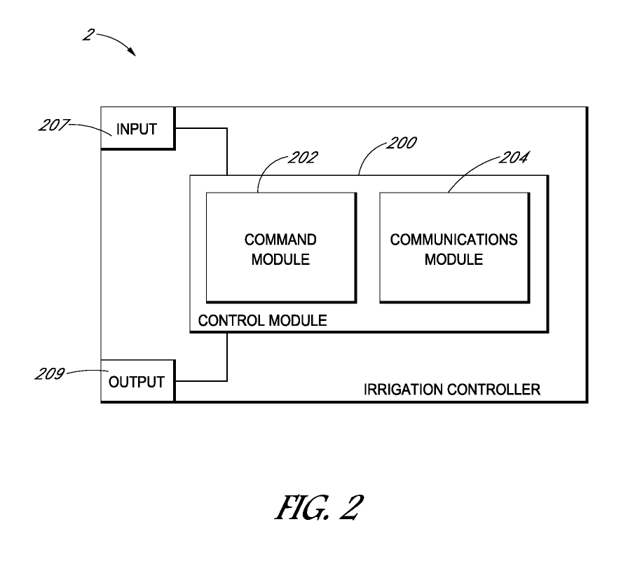

FIG. 2 is a schematic system diagram of the irrigation controller 2, according to one embodiment. The irrigation controller 2 can include an electrical input connection 207 configured to electrically communicate with the control unit 110 and an electrical output connection 209 configured to electrically communicate with the one or more valves 120 of the irrigation system 100. The irrigation controller 2 can comprise a control module 200 configured to intercept commands sent from the control unit 110 of the irrigation system 100 to the one or more valves 120. In some embodiments, the control module 200 can comprise a command module 202 which can act as a switch to selectively allow or prevent the intercepted commands from the control unit 110 from reaching the one or more valves 120. In some embodiments, the command module 202 of the irrigation controller 2 can be configured to modify the intercepted commands and transmit the modified commands to the one or more valves 120. In some arrangements, the irrigation controller 2 receives and processes the intercepted commands but does not modify the commands before transmitting the commands to the valve(s) 120.

The command module 202 can comprise one or more processors in data communication with one or more non-transitory computer-readable media. The command module 202 of the control module 200 can be configured to monitor instructions received at the electrical input connection 207 from the control unit 110, the instructions comprising commands for opening or closing the one or more valves 120. For example, in some embodiments, the commands for opening the one or more valves 120 can comprise an ON signal, and the commands for closing the one or more valves 120 can comprise an OFF signal. In some arrangements, the controller 2 can store the commands in a database on non-transitory computer-readable media so as to create a report or history of the irrigation of the parcel over time. The user can review the report or history to monitor daily watering schedules and overall water consumption. Thus, the control module 200 can be configured to record the time and duration that each valve 120 of the one or more valves is open over a pre-determined time period.

The control module 200 of the irrigation controller 2 can also comprise a communications module 204 which can be configured to receive data transmitted over a communications network from an external communications system, such as a mobile computing device 4, one or more central servers 5, the Internet, and/or any other suitable device or networked entity. For example, the communications module 204 of the irrigation controller 2 can receive information about at least one of: current weather conditions, local water control restrictions, local moisture content, location of the external irrigation system, user-defined limits, and flow rate of water through the external irrigation system. As an example, the communications module 204 may communicate with a publicly available weather website (or, alternatively, a private weather server) to learn that the local area is experiencing flooding conditions or drought conditions. As another example, the communications module 204 can communicate with government websites or news websites to learn that the local government has imposed restrictions on the amount of water used in irrigation systems. In some arrangements, the communications module 204 can monitor the Internet for news alerts relating to changing weather conditions or water regulations for a particular locality or region. Moreover, in some arrangements, the user can change his or her preferences with respect to the irrigation settings. The irrigation controller 2 can communicate with the external communications system by way of a wired communications network or a wireless communications network (e.g., wireless internet or WiFi, cellular networks, Bluetooth networks, etc.).

The irrigation controller 2 can be configured to modify the commands for opening or closing the one or more valves based at least in part on the data received by the communications module 204. The control module 200 can be configured to transmit the modified commands from the electrical output connection 209 to the one or more valves 120. For example, if the local area is experiencing flooding conditions, if local watering restrictions indicate that the parcel of land is approaching or exceeding watering limits, and/or if local sensors indicate that the soil to be watered is already sufficiently moist, the irrigation controller 2 can reduce or stop the flow of water through the valves 120 (or decrease the frequency or duration of irrigation) by sending a suitable control signal to the valves 120, or by interrupting an ON signal from the conventional control unit. If the local area is experiencing drought conditions, the irrigation controller 2 can increase the flow of water through the valves 120, or increase the frequency or duration of irrigation (e.g., if local watering restrictions permit), relative to the amount of flow permitted when the soil is already moist or rain is forecast. In some arrangements, based on the received data, the irrigation controller 2 can transmit the commands from the control unit 110 without modifying them. In some arrangements, rather than actively transmitting commands, the irrigation controller can fail to interrupt the signals sent form the control unit 110 to the valves 120. For example, if the original commands from the control unit are adequate for current weather conditions or water restrictions, the irrigation controller 2 may not modify the commands or interrupt the signal, and the one or more valves 120 may supply water to the areas to be irrigated according to the instructions transmitted by the control unit 110. Thus, the irrigation controller 2 can be configured to modify the commands and transmit the modified commands by: opening a switch within the irrigation controller 2 to prevent the commands from being transmitted to the one or more valves 120 (and to thereby prevent water from flowing through the associated irrigation line(s) 140) or closing the switch to allow the commands to be transmitted to the one or more valves 120 (and to thereby allow water to flow through the associated irrigation line(s) 140). Thus, the irrigation controller 2 can be configured to allow the maximum amount of irrigation programmed into the control unit 110, or to reduce the flow relative to the control unit 110 programming according to external factors communicated through the communications module 204.

Referring back to FIG. 1, the irrigation control system 1 can also include a master control valve 3 configured to be disposed on the water supply line 130 upstream of the one or more valves 120. The master control valve 3 can be configured to determine at least one of an amount of water flowing through the water supply line 130 to the one or more valves 120 and a time period during which water flows through the water supply line 130 to the one or more valves 120. The master control valve 3 can include a valve body configured to be disposed on the water supply line 130 upstream of the one or more valves 120 of the external irrigation system 100. The valve body can be configured to modify a flow of water through the water supply line 130.

The master control valve 3 can include a sensor configured to transduce information regarding the flow of water through the water supply line 130 and to generate a signal based on the transduced information. The sensor can comprise any suitable type of sensor, such as flow rate sensors, pressure sensors, etc. The master control valve 3 can include a control module comprising one or more processors in communication with a non-transitory computer-readable medium. The control module can be configured to receive the signal from the sensor. The control module of the master control valve 3 can also be configured to process the received signal to determine at least one of an amount of water flowing through the water supply line 130 to the one or more valves 120 and a time period during which water flows through the water supply line 130 to the one or more valves 120. The control module of the master control valve 3 can also be configured to transmit the processed signal over a communications network to an external communications system, such as the mobile computing device 4, the central server 5, or any other suitable communications system. As explained above, the communications network can comprise a wired communications network or a wireless network (such as WiFi, cellular networks, Bluetooth networks, etc.).

The control module of the master control valve 3 can also be configured to receive valve data from the irrigation controller 2. For example, the master control valve 3 can receive valve data that includes a schedule for each valve 120 of the one or more valves. The schedule can comprise at least one of a time at which the corresponding valve 120 is scheduled to run and a duration during which the corresponding valve 120 is scheduled to run. Thus, the master control valve 3 may know which valve 120 is supposed to be open at a particular time. If the schedule indicates that a particular valve is supposed to be open but the sensor does not detect any flow of water through the supply line 130, then the master control valve 3 may indicate that the valve 120 is stuck in a closed state. Similarly, if the schedule indicates that the valves 120 are supposed to be closed at a particular time but the sensor detects that water is flowing through the supply line, then the master control valve 3 can indicate that one or more of the valves 120 is stuck in an open state. The master control valve 3 can be configured to stop or reduce the flow of water through the supply line 130 if the master control valve 3 detects that a valve is stuck open. The master control valve 3 can communicate these notifications to the user by way of the communications network (e.g., to the user's mobile device 4).

In some embodiments, the master control valve 3 can report water usage to the user and can notify the user if the system 100 is exceeding local water restrictions. Further, in some arrangements, such as low-pressure drip systems, the master control valve 3 can be configured to lower the pressure supplied by the supply line 130 to the valves 120. In various arrangements, the master control valve 3 can operate as a standalone unit without the irrigation controller 2, and vice versa.

The communications system can comprise any suitable type of computing device and can have a processor configured to receive and/or transmit data to and/or from the controller 2 and/or the master control valve 3 over various communications networks. For example, as explained herein, the central server 5 and/or the mobile computing device 4 can be connected to the World Wide Web or other information network so as to gather real-time weather information, information about local watering restrictions, local moisture content, etc. The central server 5 and the computing device 4 can communicate with one another, as well as with the irrigation controller 2 and/or the master control valve 3. The irrigation controller 2 can also be in data communication with the master control valve 3. The user can receive notifications by way of an application installed on the mobile device 4.

The irrigation controller 2 shown in FIG. 1 can connect to the control unit 110 and the one or more valves 120 in various ways. FIG. 3 is a schematic system diagram of the irrigation control system 1 shown in FIG. 1 with the irrigation controller 2 connected to a control line 6 of each valve 120. Four valves 120 are illustrated in FIG. 3: V₁, V₂, V₃, and V₄. Each valve 120 is associated with a control line 6 which transmits an electrical signal from the control unit 110 to the associated valve 120. For example, valve V₁ is connected to the control unit 110 by way of control line L₁ and switch S₁, valve V₂ is connected to the control unit 110 by way of control line L₂ and switch S₂, valve V₃ is connected to the control unit 110 by way of control line L₃ and switch S₃, and valve V₄ is connected to the control unit 110 by way of control line L₄ and switch S₄. In the absence of the controller 2, the control unit 110 controls whether each valve 120 is open or closed by sending an electrical signal along the control line 6 associated with each valve 120. For example, the control unit 110 may instruct valve V₁ to be open (to allow water to pass along the associated irrigation line 140) while keeping the other valves V₂-V₄ closed (to prevent water from passing along the associated irrigation lines 140). In this example, the control unit 110 may transmit an ON signal along line L₁ to open the valve V₁, and may transmit an OFF signal (or no signal at all) along lines L₂-L₄. As shown in FIG. 3, the system 1 can be connected to ground G by way of ground line GL.

In the embodiment of FIG. 3, the irrigation controller 2 is connected or spliced to each control line L₁-L₄ of the valves V₁-V₄. Advantageously, therefore, the irrigation controller 2 can control the opening and/or closing of each valve V₁-V₄ independently by opening or closing the associated switches S₁-S₄. For example, as explained above, if the area to be irrigated experiences flooding conditions, or if the local government has imposed watering restrictions, then the controller 2 can interrupt the signals sent to each valve V₁-V₄ by opening the switches S₁-S₄ to reduce the amount of water supplied to the irrigation lines 140. In some arrangements, the controller 2, or processing and control signals sent to it from, e.g., the central server 5, can determine how much water should be supplied to the irrigation lines 140 to comply with the watering restrictions and/or to appropriately address the flooding conditions. For example, in some arrangements, the irrigation controller 2 can prevent any irrigation during such conditions. In other arrangements, the irrigation controller 2 can monitor how much water is supplied to the irrigation lines 140 and can prevent additional irrigation after the amount of supplied water reaches a predetermined threshold.

In some embodiments, the irrigation controller 2 can be configured to supply different amounts of water to each irrigation line 140 through the valves 120. For example, if a moisture sensor or user input indicates that the area irrigated by the line 140 associated with valve V₁ is drier than the area irrigated by the line 140 associated with valve V₂, then the controller 2 may permit the control signal sent by the control unit 110 to pass to the valve V₁ for a longer period of time than the controller 2 permits the control signal to pass to the valve V₂, for example, by closing the switch S₁ for a longer period of time than the switch S₂ is closed. Advantageously, the embodiment shown in FIG. 3 can enable the controller 2 to individually control the amount of water passing through each valve 120 by selectively opening and closing the associated switches S₁-S₄. Furthermore, as explained above, the controller 2 can create a log in a memory unit which records how long each area has been irrigated over a period of time.

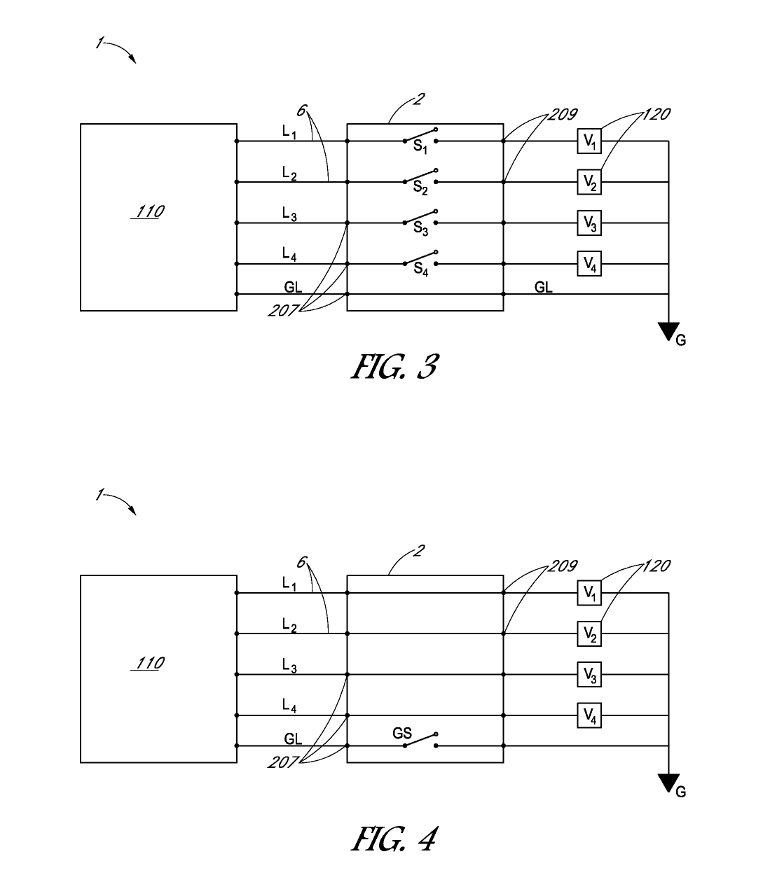

FIG. 4 is a schematic system diagram of the irrigation control system 1 shown in FIG. 1 with the irrigation controller 2 connected to a ground line GL of the system 1 having a ground switch GS. Unlike the embodiment of FIG. 3, in the implementation of FIG. 4, the controller 2 is connected or spliced to the ground switch GS of the ground line GL. When the controller 2 determines that the amount of water supplied to the irrigated areas should be reduced (e.g., during a flooding weather condition, due to a local government restriction, due to user input, etc.), then the controller 2 can open the ground switch GS along the ground line GL to open the circuit and prevent signals from passing to each valve V₁-V₄. When the controller 2 determines that water should flow through the valves V₁-V₄, the ground switch GS may be closed. Advantageously, the embodiment of FIG. 4 can control the operation of the valves V₁-V₄ through the single ground switch GS.

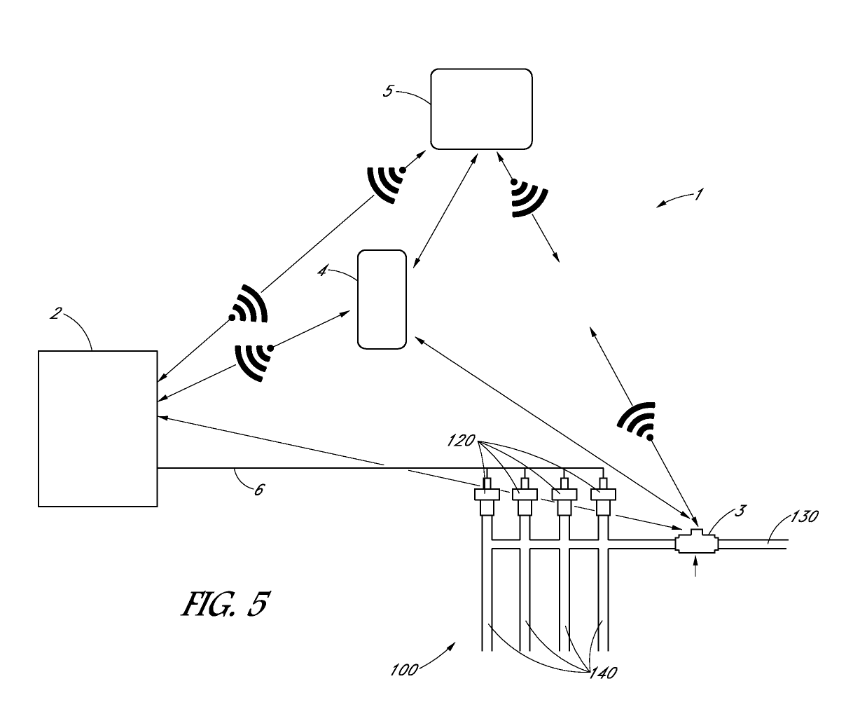

The embodiments of FIGS. 1-4 can advantageously enable a user to retrofit a conventional irrigation control unit 110 by splicing or connecting the irrigation controller 2 to the signal and/or ground lines of the system 1 when the controller 2 is installed between the control unit 110 and the valves 120. However, in other embodiments, the controller 2 can be installed to replace the control unit 110. FIG. 5 is a schematic system diagram of an irrigation control system 1, according to another embodiment. The irrigation control system 1 can include components similar to or the same as those shown in FIG. 1, except where noted herein. For example, the irrigation control system 1 can control the operation of an irrigation system 100 which includes a water supply line 130 that supplies water from a source (such as a city water supply) to a plurality of irrigation lines 140. In some arrangements, each irrigation line 140 supplies water to a particular area of a parcel of land.

Unlike the embodiment of FIG. 1, however, in the embodiment of FIG. 5, the irrigation control system 1 includes the controller 2 which can act as a standalone controller which can operate with or without (as shown) another control unit (such as the control unit 110 of FIG. 1). For example, as with the embodiment of FIG. 1, the controller 2 can communicate with an external communications system, such as mobile computing device 4, one or more central servers 5, the Internet, and/or any other suitable device or networked entity. Based on the received information, the controller 2 can increase or decrease the amount of water supplied to the area to be irrigated. For example, if the received information indicates that the area is undergoing severe rainfall conditions, or that the area is under increased watering restrictions, then the controller 2 can reduce the amount of water supplied to the supply lines 140 of the system 100, and/or can stop irrigation completely for a period of time. In addition, if the received information indicates that the area is experiencing a drought, or if watering restrictions have been lifted, then the controller 2 can increase the amount of water supplied to the supply lines 140 of the system. Thus, in the embodiment of FIG. 5, the controller 2 can increase or decrease the amount of water supplied to the irrigated areas without including a separate control unit.

In still other embodiments, the control unit 110 of FIG. 1 can be updated with hardware, software, and/or firmware which provides the control unit 110 with the functionality of the controller 2 without splicing a separate controller into the system 1. For example, the control unit 110 can be fitted with additional hardware components or may be installed with additional software components which can modify the flow of water to the irrigation lines 140 based on information received by the control unit 110 from the external communication systems.

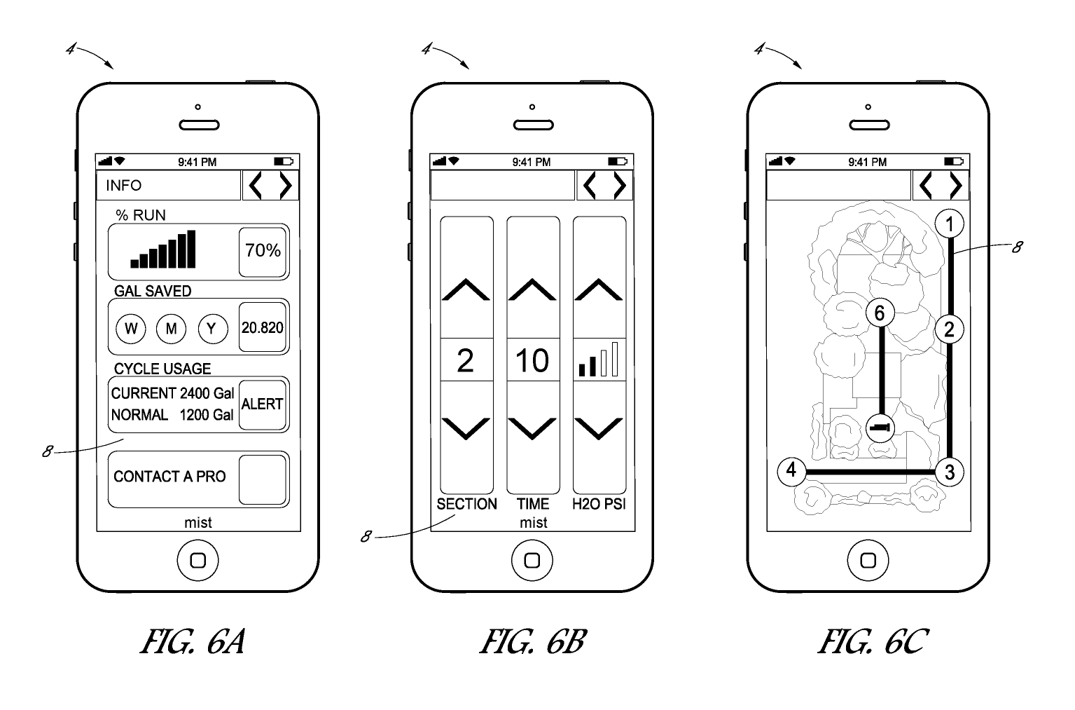

FIGS. 6A-6C are schematic diagrams of a mobile device 4 with a user interface 8 that is configured to control the operation or set-up of the irrigation control systems disclosed herein. For example, the user interface 8 can comprise an application (or “app”) installed on the mobile device 4. The user can thereby view and/or modify the settings of the irrigation system 100 and the irrigation control system 1 by way of the interface 8. The user can also view the watering history of the parcel of land. As shown in FIG. 6A, for example, the user can view the overall water usage and volume of water saved over a particular time period. In the interface 8 of FIG. 6B, the user can modify the watering time and/or pressure for each region of the parcel. As shown in FIG. 6C, the user can view a map or schematic drawing of the parcel of land to see which irrigation lines 140 pass through which region of the parcel. Still other user interface arrangements are possible. The user interface 8 of FIGS. 6A-6C can be used with any of the embodiments shown in FIGS. 1-5.

For example, for the embodiments of FIGS. 1-4, to install the controller 2, the user can electrically connect the controller 2 to the control lines (FIG. 3) and/or the ground line GL (FIG. 4) of the system 1 between the control unit 110 and the valves 120. For the embodiment of FIG. 5, the user can install the controller 2 with the associated irrigation system 100. The user can navigate through the user interface 8 to complete a setup procedure on a software application installed on the user's mobile device 4 or other type of computing device. For example, the user interface 8 can prompt the user to set up the wireless capabilities of the controller 2 (e.g., WiFi, Bluetooth, cellular networks, etc.). The user may select on the user interface 8 a source of weather information for the region, such as a weather website, a private weather server, a local weather station, etc. The user interface 8 can prompt the user to set up various user preferences, such as instructing the controller 2 to not irrigate the area if rain is forecasted within a predetermined time period (e.g., within the next 12 hours, 24 hours, 48 hours, etc.) and/or above a certain percentage of rain forecast (e.g., above 60% chance of rain). The user interface 8 can prompt the user to select preferences regarding temperature conditions, such as providing instructions to not irrigate the area if the temperature drops below a predetermined temperature (e.g., below 50° F., below 40° F., below 30° F., etc.). The user interface 8 may prompt the user for preferences regarding whether or not to irrigate the area during a particular time of year or range of dates, such as winter (e.g., between the months of November and March). In some arrangements, the controller may irrigate the area during the range of dates if the temperature rises above a predetermined temperature. In some embodiments, the user interface 8 can prompt the user for instructions regarding how much to irrigate at various temperatures, e.g., the user may elect to irrigate at a certain percentage of a maximum water limit at various temperature ranges, e.g., at 75% of the water limit if the temperature drops to 70° F., at 60% of the water limit if the temperature drops to 65° F., at 50% of the water limit if the temperature drops to 60° F., at 40% of the water limit if the temperature drops to 55° F., at 25% of the water limit if the temperature drops to 50° F., and to shut off the water if the temperature drops to below 50° F.

The user interface 8 can also prompt the user regarding preferences for monitoring local watering restrictions and/or for sending the user a periodic (e.g., monthly) report of water usage. In some mobile computing applications, the user interface 8 may provide the user with the option to request an instant or “push” notification of the total run time of each irrigation line, and to request a notification (by e-mail or text message, for example) if no irrigation has occurred for a predetermined period of time (e.g., within the last 48 hours, etc.). The user interface 8 can also allow the user to set a master run time limit which limits the maximum amount of time the area is irrigated within a period of time (e.g., within a given 24 hour period), and the user can choose whether to have the system notify the user if the master run time limit is met. Notifications can also be sent to the user if changes have been made to the controller 2 or if unusually hot weather is forecast in the near future. In some embodiments, the controller 2 can determine, based on the information received from the external communications systems, how long a particular region should be watered and can communicate that information to the user by way of the user interface 8. The controller 2 can also suggest to the user how much to water the parcel of land on a monthly basis, and can communicate that information to the user by the user interface 8. For example, the controller 2 can suggest to the user that the system 1 supply 100% of the maximum water limits in July and August, 90% of the maximum water limits in September, 70% of the maximum water limits in October, 40% of the maximum water limits in November, etc.

All of the features described above may be embodied in, and automated by, software modules executed by processors or integrated circuits of general purpose computers. The software modules may be stored in any type of non-transitory computer storage device or medium. All combinations of the various embodiments and features described herein fall within the scope of the present invention.

Embodiments disclosed herein can be operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A Local Area Network (LAN) or Wide Area Network (WAN) may be a corporate computing network, including access to the Internet, to which computers and computing devices comprising the system are connected. In one embodiment, the LAN conforms to the Transmission Control Protocol/Internet Protocol (TCP/IP) industry standard.

A microprocessor may be any conventional general purpose single- or multi-chip microprocessor such as a Pentium® processor, Itanium® processor or an ALPHA® processor. In addition, the microprocessor may be any conventional special purpose microprocessor such as a digital signal processor (DSP) or a graphics processor.

The system is comprised of various modules as discussed in detail below. As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as LINUX, UNIX or MICROSOFT WINDOWS®. The system may be written in any conventional programming language such as C, C++, BASIC, Pascal, Perl, or Java, and run under a conventional operating system.

In some embodiments, a web browser comprising a web browser user interface may be used to display information (such as textual and graphical information) to a user. The web browser may comprise any type of visual display capable of displaying information received via a network. Examples of web browsers include Microsoft's Internet Explorer browser, Apple's Safari Browser, Mozilla's Firefox browser, Google's Chrome browser or any other browsing or other application software capable of communicating with a network. Further, information may also be configured for and displayed in other suitable applications, such as applications programmed for implementation in mobile devices, such as mobile phones or other mobile computing devices. For example, a platform-specific application (or “app”) may be used to display information to a user and/or receive user inputs. For example, applications may be used in conjunction with Apple products such as the iPad or iPhone, with Google Android tablet computers or phones, and/or with any other type of computing device.

The embodiments disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

Although the various inventive features and services have been described in terms of certain preferred embodiments, other embodiments that are apparent to those of ordinary skill in the art, including embodiments which do not provide all of the benefits and features set forth herein and do not address all of the problems set forth herein, are also within the scope of this invention. The scope of the present invention is defined only by reference to the appended claims

What is claimed is:

1. An irrigation controller comprising:
an electrical input connection configured to electrically communicate with a control unit of an irrigation system;
an electrical output connection configured to electrically communicate with one or more valves of the irrigation system; and
a control module comprising one or more processors and configured to:
monitor instructions received at the electrical input from the control unit, the instructions comprising commands for opening or closing the one or more valves;
receive data transmitted over a communications network from an external communications system; and
prevent, allow or modify the commands for opening or closing the one or more valve to be transmitted from the electrical output connection to the one or more valves based at least in part on the received data.

2. The irrigation controller of claim 1, wherein the control module is configured to open a switch to prevent the commands from being transmitted to the one or more valves or close the switch to allow the commands to be transmitted to the one or more valves.

3. The irrigation controller of claim 1, wherein the control module is configured to transmit the monitored instructions over the communications network to at least one of a central server and a mobile computing device.

4. The irrigation controller of claim 1, wherein the received data comprises at least one of: current weather conditions, local water control restrictions, local moisture content, location of irrigation system, user-defined limits, and flow rate of water through the irrigation system.

5. The irrigation controller of claim 1, wherein the external communications system comprises at least one of a mobile computing device, a central server, and a master control valve coupled with a main supply line to the irrigation system.

6. The irrigation controller of claim 1, wherein the control module is configured to transmit the commands for opening or closing the one or more valves to the one or more valves without modifying the commands.

7. The irrigation controller of claim 1, wherein the commands reduce or stop the flow of water through the one or more valves.

8. The irrigation controller of claim 1, wherein the communications network comprises a cellular network, a wireless internet network, or a Bluetooth network.

9. The irrigation controller of claim 1, wherein the control module is configured to record the time and duration that each valve of the one or more valves is open over a pre-determined time period.

10. A master control valve comprising:
a valve body configured to be disposed on a water supply line upstream of one or more valves of an irrigation system, the valve body configured to control a flow of water through the water supply line;
a sensor configured to transduce information regarding the flow of water and to generate a signal based on the transduced information; and
a control module comprising one or more processors and configured to:
receive the signal from the sensor;
process the received signal to determine at least one of an amount of water flowing through the water supply line to the one or more valves and a time period during which water flows through the water supply line to the one or more valves; and
transmit the processed signal over a communications network to an external communications system.

11. The master control valve of claim 10, wherein the control module is configured to receive valve data from an irrigation controller, the valve data including a schedule for each valve of the one or more valves, the schedule comprising at least one of a time at which the corresponding valve is scheduled to run and a duration during which the corresponding valve is scheduled to run.

12. The master control valve of claim 10, wherein the communications network comprises a cellular network, a wireless internet network, or a Bluetooth network.

13. The master control valve of claim 10, wherein the control module is configured to detect whether a particular valve is stuck open and, in response, to send instructions to the valve body to stop the flow of water through the water supply line.

14. An irrigation control system comprising:
an irrigation controller configured to intercept commands sent from a control unit of an irrigation system to one or more valves of the irrigation system, the irrigation controller configured to prevent, allow, or modify the intercepted commands to be transmitted to the one or more valves;
a master control valve configured to be disposed on a water supply line upstream of the one or more valves, the master control valve configured to determine at least one of an amount of water flowing through the water supply line to the one or more valves and a time period during which water flows through the water supply line to the one or more valves; and
a communications system comprising one or more processors and configured to:
receive data from the master control valve over a communications network, the data related to a flow of water through the water supply line; and
transmit information to the irrigation controller, the information comprising at least one of: current weather conditions, local water control restrictions, local moisture content, location of the irrigation system, user-defined limits, and flow rate of water through the irrigation system.

15. The irrigation control system of claim 14, wherein the communications system comprises one or more central servers.

16. The irrigation control system of claim 14, wherein the communications system comprises a mobile computing device.

17. The irrigation control system of claim 14, wherein the communications system is configured to collect data from the Internet regarding one or more of current weather conditions, local water control restrictions, and local moisture content.

18. The irrigation control system of claim 14, wherein the communications system is configured to receive data from the irrigation controller comprising the time and duration that each valve of the one or more valves is open over a pre-determined time period.

19. An irrigation control system comprising:
an irrigation control unit configured to be programmed by a user to control the operation of an irrigation system;
one or more valves in electrical communication with the irrigation control unit, the one or more valves controlling the flow of water to one or more irrigation lines in response to a control signal sent from the irrigation control unit;
an irrigation controller disposed between and in electrical communication with the irrigation control unit and the one or more valves, the irrigation controller configured to intercept commands sent from the control unit to the one or more valves, the irrigation controller configured to receive data over a communications network from an external communications system and configured to interrupt the control signal based at least in part on the received data.

20. The irrigation control system of claim 19, further comprising a master control valve disposed on a water supply line upstream of the one or more valves, the master control valve configured to determine at least one of an amount of water flowing through the water supply line to the one or more valves and a time period during which water flows through the water supply line to the one or more valves.
